(19) United States
(12) Patent Application Publication
(10) Pub. No.: US 2010/0053595 A1
(43) Pub. Date: Mar. 4, 2010

(54) THREE DIMENSIONAL LASER RANGE FINDER SENSOR

(76) Inventor: Kap Jin Lee, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/546,416

(22) Filed: Aug. 24, 2009

(30) Foreign Application Priority Data
Aug. 29, 2008 (KR) 10-2008-0085234

(51) Int. Cl. G01C 3/08

(52) U.S. Cl. 356/5.01

(57) ABSTRACT

A 3D laser range finder sensor is disclosed wherein the sensor comprises: a reflection body for reflecting an emitted light and an incident light; a horizontal rotation body for rotating the reflection body; a vertical moving body for tilting the reflection body; and a body irradiating the emitted light to the reflection body and receiving the incident light through reflection from the reflection body.

### CROSS-REFERENCE TO RELATED APPLICATION

This application claims the benefit under 35 U.S.C. §119 of Korean Application Number 10-2008-0085234, filed Aug. 29, 2008, which is hereby incorporated by reference in its entirety.

### BACKGROUND

The following disclosure relates to a three dimensional (3D) laser range finder (LRF) sensor, and more particularly to a 3D laser range finder sensor capable of determining presence or absence of a target object, a position of the object and a distance to the object on a 3D space by emitting light to the object and receiving the light reflected from the object.

A laser range finder (LRF) sensor generally including a light source, a rotation body and a sensor is operated based on the principle of sending a light emitted from a light source toward the target object, and then receiving and detecting, by a sensor, a signal reflected off the target object, whereby a traveling time of the signal is measured and the distance to the target object is obtained using a series of numerical calculations.

The rotation body is capable of rotating the light source and the sensor to conduct all the performances within a given angle. The LRF sensor is largely configured to perform a distance determination of a portion in the first dimension. That is, the LRF sensor is generally configured to scan a horizontal object.

### BRIEF SUMMARY

In order to realize a 3D LRF sensor capable of horizontal and vertical direction scanning, a reflection mirror inside a laser range finder structure must be able to perform a horizontal adjustment and an inclination adjustment as well, and therefore, there is required a structural method of simply realizing the adjustment. An exemplary embodiment of the present invention is to provide a 3D laser range finder sensor capable of spatial recognition in the horizontal direction and the vertical direction as well.

In one general aspect of the present invention, a 3D laser range finder sensor is provided comprising: a reflection body for reflecting an emitted light and an incident light; a horizontal rotation body for rotating the reflection body; a vertical moving body for tilting the reflection body; and a body irradiating the emitted light to the reflection body and receiving the incident light through reflection from the reflection body.

### BRIEF DESCRIPTION OF THE DRAWINGS

FIG. 1 is an external perspective view of a 3D laser range finder (LRF) sensor and an internal perspective view of an LRF structure according to an exemplary embodiment of the present invention.

FIG. 2 is an exploded cross-sectional view of an LRF structure according to an exemplary embodiment of the present invention.

FIG. 3 is a combined cross-sectional perspective view of an LRF structure in which a horizontal rotation body, a vertical moving body and a reflection body are combined.

FIG. 4 is a graphic illustrating a rotated shape of a mirror according to an exemplary embodiment of the present invention.

FIG. 5 is a graphic illustrating a combined shape of a rear part coupler according to an exemplary embodiment of the present invention.

FIG. 6 is a graphic illustrating a changed shape of an inclination of a mirror according to an exemplary embodiment of the present invention.

### DETAILED DESCRIPTION

Reference will now be made in detail to the exemplary embodiments of the present invention, examples of which are illustrated in the accompanying drawings. Wherever possible, the same reference numerals will be used throughout the drawings to refer to the same or like parts.

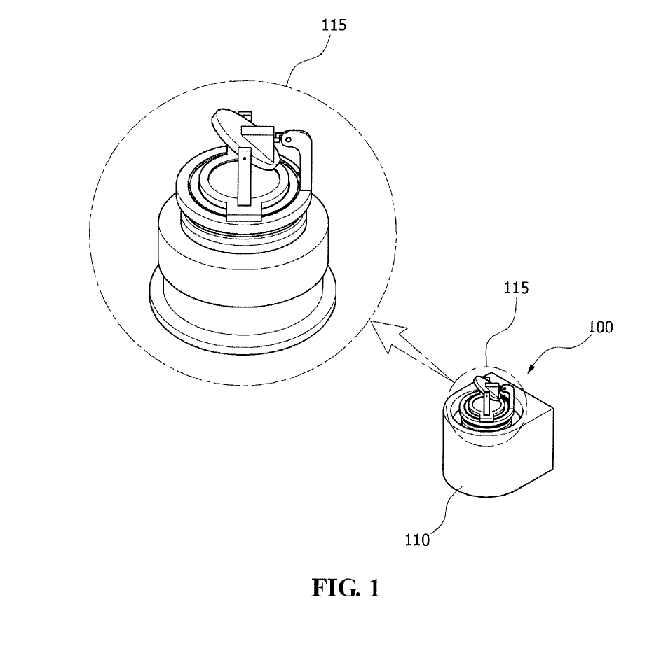

FIG. 1 is an external perspective view of a 3D laser range finder (LRF) sensor and an internal perspective view of an LRF structure according to an exemplary embodiment of the present invention.

The 3D laser range finder (LRF) sensor may include a body 110 and an LRF structure 115, where the body 110 may include a light reception element sensing an incident light signal as an incident light, a light collection lens collecting the incident light signal to the light reception element, and a light emitting element emitting light using a laser.

The light emitted from the light emitting element is reflected by a reflection mirror 121 and emitted to outside as a signal light. At this time, a point to which the light is emitted varies according to a rotation position and an inclination of the mirror 121. In a case where the emitted light hits an object and returns as a signal light, the signal light is reflected by the mirror to be incident on the body 110, and incident on the light reception element via the light collection lens of a fixed body. As a result, the body 110 irradiates the emitted light, emits the light via the mirror, and performs a scanning of collecting via the mirror the incident light returning from the object after hitting the object.

The LRF structure 115 performs a 3D spatial recognition (distance recognition) via the rotation and inclination of the mirror. The mirror is connected via a base plate 123 and a mirror support, where the mirror is rotated in response to the rotation of the base plate 123. The mirror is moved along a hinge by way of a vertical driving link connected to the vertically-moving link bases to show an inclination change.

At this time, the changes of rotation and inclination of the mirror are simultaneously implemented to perform a 3D scanning. The mirror also reflects the emitted light and the incident light to enable a 3D spatial recognition. To this end, the LRF structure may include a horizontal rotation body, a vertical moving body, and a reflection body.

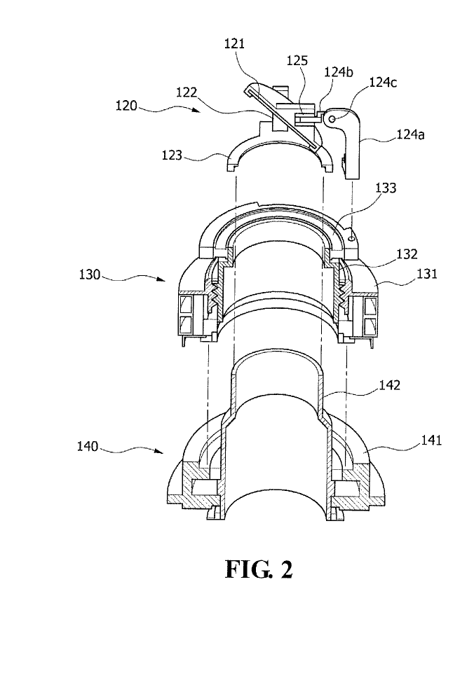

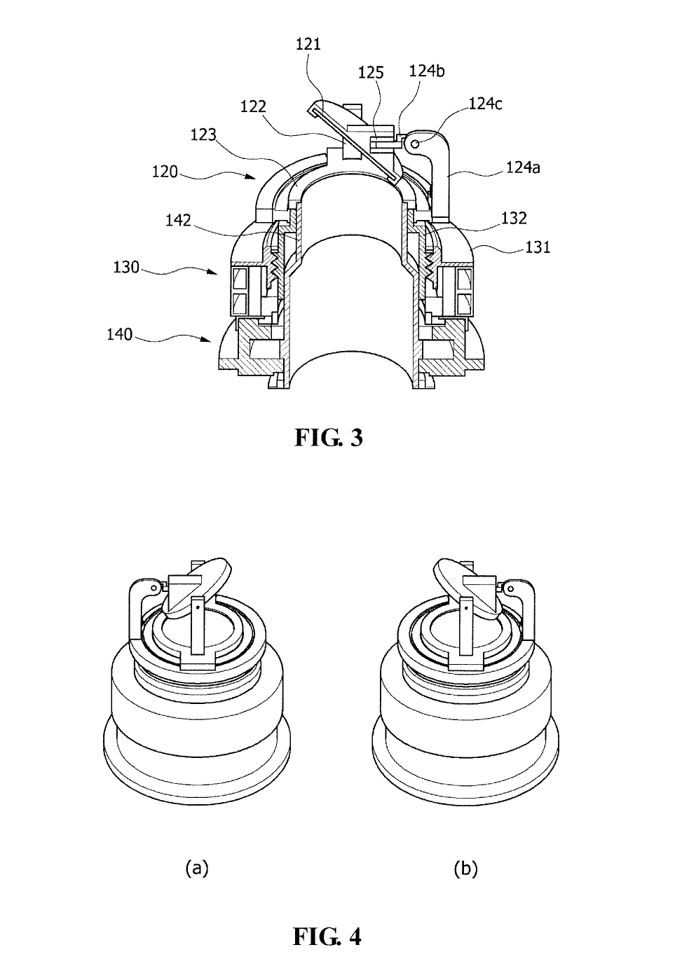

FIG. 2 is an exploded cross-sectional view of an LRF structure according to an exemplary embodiment of the present invention, and FIG. 3 is a combined cross-sectional perspective view of an LRF structure in which a horizontal rotation body, a vertical moving body, and a reflection body are combined.

The horizontal rotation body 140 is formed at a bottom surface of the reflection mirror 121 and rotates a hollow pipe 142 via a horizontal driving motor 141 operating just like a spindle motor. A rotation shaft of the horizontal driving motor is a hollow axle comprising a hollow pipe 142 that is hollow in its center. An emitted light or an incident light passing the mirror 121 via an interior of the hollow pipe is transmitted to outside or to the body through the interior of the hollow pipe.

In order to implement the rotation of the hollow pipe 142, the horizontal driving motor 141 encompasses a lower distal end of the hollow pipe to realize the rotation of the hollow pipe 142. An upper distal end of the hollow pipe 142 is fixed at the base plate of a reflection body 120, where the base plate 123 is formed with a mirror support 122 which a support axle connectively supporting the mirror 121.

The hollow pipe 142 is rotated 360 degrees in response to the rotation of the horizontal driving motor, and the rotation of the base plate 123 connected to the hollow pipe is realized by the rotation of the hollow pipe 142. The rotation of the base plate 123 enables the rotation of the mirror support 122 connected to the base plate 123 and, resultantly, the rotation of the mirror 121 is performed by the rotation of the mirror support 122. Two mirror supports 122 are configured, i.e., one mirror support 122 at each side of a diameter of the base plate 123.

Each scanning image that is a result of the rotation of the mirror 121 is shown in FIGS. 4(a) and 4(b), where FIG. 4(a) is a graphic illustrating a measured image of the 3D LRF sensor at a particular position, and FIG. 4(b) is a graphic illustrating a measured image of the 3D LRF sensor at a position where a mirror is rotated 180° from a position of FIG. 4(a).

Referring to FIG. 4(a), light emitted from a light emitting element inside the body is emitted to the right side via the mirror, such that a scanning is realized where the incident light enters from the right side, passes the mirror, and enters into the light reception element within the body.

Meanwhile, in a case where the mirror is rotated 180° by the rotation of the rotation body, as shown in FIG. 4(b), the light emitted from the light emitting element passes the mirror and is emitted to the left, whereby a scanning is realized in which the incident light enters from the left side, passes the mirror and enters the light reception element inside the body.

Meanwhile, a vertical moving body 130 may include a linear stepping motor and a vertical driving motor and is disposed at an outside of the hollow pipe 142. The vertical moving body 130 may include an external body 131, a screw 132, a link base 134, and a bearing 133.

The external body 131 is formed therein with a screw thread, and the screw 132 is rotated along the screw thread to vertically move along the hollow pipe 142. The link base 134 wraps an outer periphery at an upper end of the screw 132 to make it possible to rotate along the outer periphery of the upper end of the screw 132. The bearing 133 is interposed between the upper end of the screw 132 and the link base 134 to absorb a difference between a rotation speed of the hollow pipe 142 and that of the screw 132.

To be more specific, in a case wherein the vertical driving motor is rotated by a control which is separate from that of the horizontal rotation body, the screw 132 inside the external body 131 is rotated along the screw thread and moves vertically. The screw 132 formed inside is so configured as to maintain a predetermined gap from the hollow pipe, whereby the screw 132 is rotated along the screw thread of the external body 131 apart from the hollow pipe to vertically rotate the screw.

The bearing 133 is disposed at an upper outer periphery of the screw, and the link base 134 is disposed on the bearing. The link base 134 is connected to a vertical driving link 124 of the reflection body. The vertical driving link 124 serves to adjust the inclination of the mirror, where a vertical axle 124a of the vertical driving link is also vertically moved in response to the vertical movement of the link base 134 disposed at an outer periphery of the screw.

That is, when the screw is vertically moved, the link base 134 connected to the screw is vertically moved at the same time and, as a result, the vertical axle 124a of the vertical driving link 124 connected to the link base 134 is also vertically moved to adjust the inclination of the mirror 121.

Meanwhile, the link base 134 is vertically moved by the rotation of the screw and rotated by the horizontal driving motor 141 as well. That is, in a case where the mirror 121 is rotated by the rotation of the base plate 123 connected to a central axle, the vertical driving link 124 is also rotated as a result of the rotation of the mirror 121, and the link base 134 is also rotated by the rotation of the vertical driving link 124.

At this time, there may be generated a speed difference between the rotation of the link base in response to the rotation of the horizontal driving motor 141 and the rotation of the screw 132, and the speed difference can be buffered by the bearing 133 interposed between the link base 134 and the screw 132.

That is, the bearing 133 serves to absorb the rotation speed difference between the rotation speed of the hollow pipe 142 in response to the rotation of the horizontal driving motor and the rotation of the vertical driving motor, whereby a smooth operation can be performed.

The reflection body 120 functions to reflect the emitted light and the incident light by vertically moving the emitted light and the incident light 360°. The reflection body 120 may include a mirror 121, a mirror support 122, a base plate 123, and a vertical driving link 124.

The mirror 121 is operated on the principle of being changed in rotation and inclination thereof, and serves to reflect the emitted light and the incident light. The mirror support 122 functions to connect diametral sides of the mirror 121 to an upper distal end of the hollow pipe 142 to rotate the mirror in response to the rotation of the hollow pipe 142. The upper distal end of the hollow pipe 142 and the mirror support 122 are connected by the base plate 123. Meanwhile, the vertical driving link 124 serves to connect the mirror 121 to the link base 134 to change the inclination of the mirror in response to the vertical movement of the link base.

As noted above, the vertical driving link 124 is vertically moved in response to the vertical movement of the link base, where a hinged connector 124b may be moved to change the inclination of the mirror.

Therefore, the vertical driving link 124 may include a vertical axle 124a vertically connected to the link base and the connector axle 124b connected to a distal end of the vertical axle via a hinge, where the other distal end of the connector axle 124b is connected to a rear coupling body 125 of the mirror.

The vertical axle 124a and the connector axle 124b are connected by a hinge 124c of spherical plane to change the inclination of the mirror 121 in response to the connector axle 124b being moved along the hinge by the vertical movement of the vertical axle 124a.

At this time, the connector axle 124b connected the mirror may be changed in length thereof when the inclination of the mirror is changed, whereby displacement of the horizontal direction of the mirror may be hindered.

In order to solve the problem, the mirror 121 and the vertical driving link 124 are operated in such a manner that the other distal end of the connector axle inserted for constantly maintaining the length of the connector axle according to the changed inclination of the mirror is made to change in response to the inclination of the mirror. The rear coupling body 125 is connected in the same way as that of a linear ball bush. In order to absorb the inclination of the mirror, a distal end of the connector axle is connected to the linear ball bush mounted at the mirror.

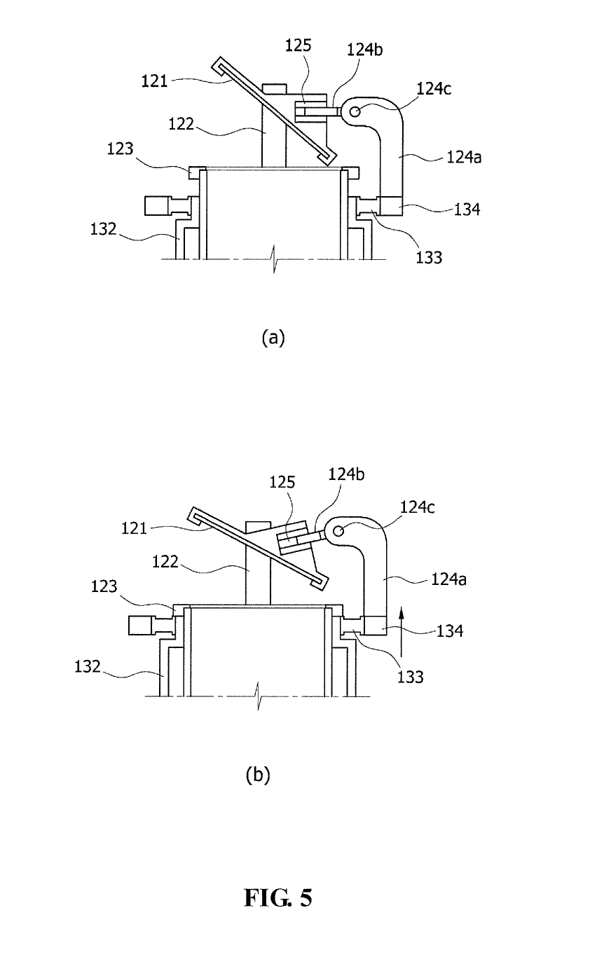

For example, as shown in FIG. 5(a), in case that the mirror is inclined to 45°, the connector axle is deeply inserted into the linear ball bush, and in case the mirror is inclined to less than 45°, as shown in FIG. 5(b), it can be noted that the connector axle is inserted by being pushed outside of the linear ball bush as compared in the mirror being inclined to 45°.

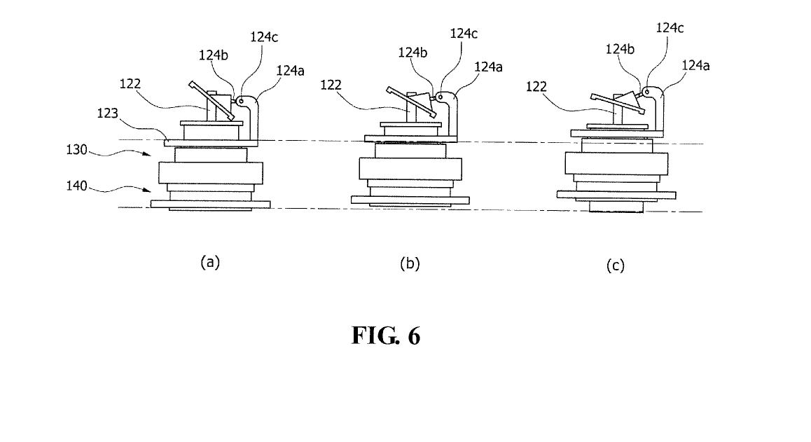

FIG. 6 is a graphic illustrating a changed shape of an inclination of a mirror according to an exemplary embodiment of the present invention, where it can be noted that the screw is vertically rotated along the screw thread in response to the rotation of the vertical driving motor, and there is a change of inclination on the part of the mirror as the vertical driving link connected to an outer periphery of the screw is vertically moved.

That is, in a case that the screw is centrally located, the mirror maintains a constant inclination (e.g., 45°), as shown in FIG. 6(b), but the mirror 121 has a steep inclination (e.g., 60°), as shown in FIG. 6(a) in a case where the vertical driving link moves down. Alternatively, in a case where the screw moves upwards to move the vertical driving link connected thereto upwards, the mirror 121 has a smaller inclination (e.g., 30°), as shown in FIG. 6(c).

There is an industrial applicability in the 3D laser range finder sensor according to the exemplary embodiments of the present invention in that the mirror can perform a 360°-rotation and simultaneously can adjust an inclination of the mirror differently to measure a 3D distance.

There is an advantageous effect in the exemplary embodiments of the present invention in that a structure is provided that is capable of recognizing a vertical distance through horizontal rotation and inclination adjustment to enable the vertical and horizontal 3D spatial recognition.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A 3D (dimensional) laser range finder (LRF) sensor, comprising: a reflection body for reflecting an emitted light and an incident light; a horizontal rotation body for rotating the reflection body; a vertical moving body for tilting the reflection body; and a body irradiating the emitted light to the reflection body and receiving the incident light through reflection from the reflection body.

2. The sensor of claim 1, wherein the horizontal rotation body rotates the reflection body by rotating about an imaginary first axis, and the vertical moving body tilts the reflection body by moving along the imaginary first axis.

3. The sensor of claim 1, wherein the reflection body includes a mirror reflecting the emitted light and the incident light, the horizontal rotation body rotates about the imaginary first axis to rotate the mirror and includes a hollow pipe functioning as a path for the emitted light and the incident light, and the vertical moving body is positioned at an external wall of the hollow pipe to vertically move along the hollow pipe in response to the rotation of a screw and to adjust a tilting angle of the mirror connected to the screw.

4. The sensor of claim 1, wherein the horizontal rotation body comprises: a hollow pipe which is a hollow axle which rotates; and a horizontal driving motor performing the rotation of the hollow pipe by wrapping a bottom end of the hollow pipe.

5. The sensor of claim 1, wherein the vertical moving body comprises: an external body formed therein with screw threads; a screw rotating along the screw threads to vertically move; a link base rotating along an outer periphery of the an upper end of the screw by wrapping the upper end of the screw; and a bearing interposed between the upper end of the screw and the link base to absorb a difference between a rotation speed of the horizontal moving body and the screw.

6. The sensor of claim 5, wherein the reflection body comprises: a mirror reflecting the emitted light and the incident light where rotation and inclination changes are generated; a mirror support for generating the rotation of the mirror in response to the rotation of the horizontal rotation body; a base plate connecting the mirror support to an upper end of the horizontal rotation body; and a vertical driving link connecting the mirror to the link base for generating an inclination change of the mirror in response to the vertical movement of the link base.

7. The sensor of claim 6, wherein the vertical driving link comprises: a vertical axle vertically connected to the link base; and a connector axle where one distal end of the connector axle is connected to the vertical axle via a hinge and the other distal end of the connector axle is connected to a rear coupling body of the mirror.

8. The sensor of claim 7, wherein a connected position between the rear coupling body and the other distal end of the connection axle moves in response to the inclination of the mirror.

9. The sensor of claim 7, wherein the connected position between the rear coupling body and the other distal end of the connection axle is provided with a linear ball bush.
